(19) United States
(12) Patent Application Publication
(10) Pub. No.: US 2025/0070329 A1
(43) Pub. Date: Feb. 27, 2025

(54) ELASTIC SHEET FOR ALL SOLID-STATE BATTERY AND ALL SOLID-STATE BATTERY INCLUDING SAME

(71) Applicant: Samsung SDI Co., Ltd., Yongin-si (KR)

(72) Inventors: Dongho KOO, Yongin-si (KR); Jaehwan Ha, Yongin-si (KR); Juyun Kim, Yongin-si (KR); Yujin Kang, Yongin-si (KR)

(21) Appl. No.: 18/637,532

(22) Filed: Apr. 17, 2024

(30) Foreign Application Priority Data
Aug. 22, 2023 (KR) 10-2023-0110005

(51) Int. Cl. H01M 50/121; C08J 5/18; C08L 23/06; C08L 71/02; H01M 50/131

(52) U.S. Cl. CPC H01M 50/121; C08J 5/18; C08L 23/06; C08L 71/02; H01M 50/131; C08J 2323/06; C08J 2371/02; C08L 2203/20; C08L 2205/18

(57) ABSTRACT

An elastic sheet for an all solid-state battery as well as an all solid-state battery which includes the elastic sheet for an all solid-state battery, wherein the elastic sheet for an all solid-state battery includes a spherical polymer which has a sphericity of about 0.6 to about 0.95 as well as including a binder.

### CROSS-REFERENCE TO RELATED APPLICATION

This application claims priority to and the benefit of Korean Patent Application No. 10-2023-0110005 filed in the Korean Intellectual Property Office on Aug. 22, 2023, the entire contents of which are incorporated herein by reference.

### BACKGROUND

### 1. Field

Embodiments relate to an elastic sheet for an all solid-state battery and an all solid-state battery including the same.

### 2. Description of the Related Art

Recently, with the rapid spread of electronic devices such as mobile phones, laptop computers, and electric vehicles using batteries, the demand for small, lightweight, and relatively high-capacity rechargeable batteries has rapidly increased.

As such a battery, the development of an all solid-state battery using a lithium metal as a negative electrode has progressed. An all solid-state battery refers to a battery in which all materials are solid and, for example, a battery using a solid electrolyte. The all solid-state battery may be structurally strong because the electrolyte is solid, and thus, there may be low risk of fire or explosion caused by electrolyte leakage due to external impact, or the like. A solid-state battery may be formed in various shapes.

### SUMMARY

Embodiments are directed to an elastic sheet for an all solid-state battery, the elastic sheet including a spherical polymer having a sphericity of about 0.6 to about 0.95; and a binder.

The sphericity of the spherical polymer may be about 0.67 to about 0.95.

The spherical polymer may include polyethylene, a polyacryl polymer, polyurethane, or a combination thereof.

The spherical polymer may be about 10 wt % to about 70 wt %, based on a total weight of the elastic sheet.

The spherical polymer may be about 20 wt % to about 60 wt %, based on a total weight of the elastic sheet.

The spherical polymer may have a particle diameter of about 0.1 μm to about 10 μm.

The binder may include polyurethane, a fluorine polymer, an acrylate resin, natural rubber, spandex, butyl rubber (Isobutylene Isoprene Rubber), an ethylene-propylene rubber, a styrene-butadiene rubber, chloroprene, elastine, rubber epichlorohydrin, nylon, terpene, isoprene rubber, polybutadiene, nitrile rubber, thermoplastic elastomer, silicon, an ethylene-propylene-diene rubber, ethylene vinyl acetate, halogenated butyl rubber, neoprene, or a copolymer thereof.

The binder may include a polyether polyol or a polyester polyol.

The elastic sheet may have a thickness of about 50 μm to about 800 μm.

Embodiments are directed to a method of forming an elastic sheet for an all solid-state battery, the method including forming a composition by mixing a spherical polymer having a sphericity of about 0.6 to about 0.95 and a binder in a solvent; coating the composition on a substrate; and photopolymerizing the composition.

The solvent may include toluene, benzene, or a combination thereof.

The substrate may be polyethylene terephthalate film.

The photopolymerization may be performed by irradiating the composition with an ultraviolet ray with a light quantity of about 1000 mJ/cm² to about 3000 mJ/cm².

The thermopolymerization may be performed by heat-treating the composition at about 70° C. to about 120° C.

Another embodiment provides an all solid-state battery including a positive electrode, a negative electrode, a solid electrolyte layer between the positive electrode and the negative electrode; and the elastic sheet positioned on outside of at least one of the positive electrode and the negative electrode.

### BRIEF DESCRIPTION OF THE DRAWINGS

Features will become apparent to those of skill in the art by describing in detail exemplary embodiments with reference to the attached drawings in which:

FIG. 1 is a schematic diagram schematically showing an all solid-state battery according to one or more embodiments; and

FIG. 2 is a cross-sectional view schematically showing an all solid-state battery according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The term “combination thereof” may include a mixture, a laminate, a complex, a copolymer, an alloy, a blend, a reactant of constituents.

The terms “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

In the specification, unless explicitly described to the contrary, the word “comprise” and variations such as “comprises” or “comprising” will be understood to imply the inclusion of stated elements but not the exclusion of any other element.

In addition, the terms “about” and “substantially” used throughout the present specification refer to the meaning of the mentioned with inherent preparation and material permissible errors when presented, and are used in the sense of being close to or near that value. They are used to help understand the present invention and to prevent unconscientious infringers from unfairly exploiting the disclosure where accurate or absolute values are mentioned. In the specification, A and/or B indicates A or B or both of them. As used herein, the term “of” is not an exclusive term, e.g., “A or B” would include A, B, or A and B.

In the present invention, “particle size” or “a particle diameter”, may be an average particle diameter. Unless otherwise defined in the specification, the average particle diameter may be defined as an average particle diameter D50 indicating the diameter of particles having a cumulative volume of 50 volume % in the particle size distribution. The particle size may be measured by an appropriate method, for example, by a particle size analyzer, or by a transmission electron microscopic image, a scanning electron microscopic image), or a field emission scanning electron microscopy (FE-SEM). In another embodiments, a dynamic light-scattering measurement device may be used to perform a data analysis, and the number of particles may be counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device.

“Thickness” may be measured through a photograph taken with an optical microscope such as a scanning electron microscope, for example.

One or more embodiments relate to an elastic sheet for an all solid-state battery. Such an elastic sheet may be referred to as a buffer layer or an elasticity layer. The elastic sheet may serve to uniformly transfer pressure to an electrode assembly including the negative electrode, a solid electrolyte, and a positive electrode, thereby facilitating good contact with the solid components and also relieving stress transmitted to the solid electrolyte, or the like. The elastic sheet may serve to buffer changes in the thickness of the electrode during charging and discharging.

An elastic sheet of an all solid-sate battery according to one or more embodiments may include a spherical polymer having a sphericity of about 0.6 to about 0.95 and a binder.

In one or more embodiments, the spherical polymer may represent a polymer having a spherical shape and, e.g., may include particles having a spherical shape. In an implementation, the spherical polymer may include particles having a sphericity of about 0.6 to about 0.95. In an implementation, the sphericity may be about 0.67 to about 0.95, or about 0.83 to about 0.95. In another implementation, the sphericity may be about 0.83 to about 0.91.

In one or more embodiments, the sphericity of the polymer particles may be obtained by taking a SEM image of the polymer particles and measuring a ratio of lengths between two axes from the SEM images. Herein, the two axes may be two axes that intersect at approximately 90 degrees passing through the center of the polymer particles.

In an implementation, the polymer according to one or more embodiments may have a spherical shape, and thus it may be substantially circle, but the polymer according to one or more embodiments may have an elliptical shape, as the sphericity may be up to about 0.95.

The polymer according to one or more embodiments may have a spherical shape, and thus, it may be defined only by the length of a long axis and a short axis which may correspond to the horizontal and vertical lengths and may not be defined by a length which may correspond to a thickness.

The inclusion of the polymer having the spherical shape in the elastic sheet may help impart cushioning, and thus, if stress is applied to the elastic sheet in the thickness direction, the elastic sheet may absorb the stress well, preventing the stress from being transmitted to the electrode assembly. Thus, safety may be improved. The elastic sheet prepared using the polymer with a spherical shape may have a relatively isotropic elastic modulus compared to an elastic sheet prepared using other shapes and may uniformly apply the pressure to the electrode assembly.

In an implementation, if sphericity of the polymer is outside of a range of about 0.6 to about 0.95, it may be difficult to uniformly apply the pressure to the electrode assembly and the isotropic elastic modulus of the elastic sheet may be deteriorated.

In one or more embodiments, the particle diameter of the spherical polymer may be, e.g., about 0.1 μm to about 10 μm, about 0.1 μm to about 8 μm, or about 0.5 μm to about 6 μm. If the sphericity of the spherical polymer is within the range of about 0.6 to about 0.95 and if the particle diameter is within the above ranges, the effects of uniformly applying pressure may be further obtained.

In an implementation, the polymer included in the spherical polymer may be polyethylene, a polyacryl polymer, polyurethane, or a combination thereof. The polyacryl polymer may be polyacrylacrylate, polyacrylmethacrylate, or a combination thereof.

The polymer may have a cushioning function, so it may help relieve the stress applied to the battery and this advantage may only be obtained from the spherical polymer. If the polymer has a linear shape, not the spherical shape, e.g., if the sphericity is outside the range of about 0.6 to 0.95, the polymer particle may be structurally anisotropic and thus, it may not be able to achieve a cushioning effect.

In an implementation, an amount of the spherical polymer may be about 10 wt % to about 70 wt %, about 20 wt % to about 60 wt %, or about 30 wt % to about 50 wt % based on a total weight of the elastic sheet. If the amount of the spherical polymer is included in the above ranges, it may be uniformly distributed in the elastic sheet and may be well mixed with the binder.

In an implementation, the binder may serve to effectively agglomerate the spherical polymers with each other, and may be a material with elasticity, so that any material may be used, as long as it has this function.

In an implementation, the binder may include, e.g., polyurethane, a fluorine polymer, acrylate resin, natural rubber, spandex, a butyl rubber (e.g., Isobutylene Isoprene Rubber, IIR), an ethylene-propylene rubber (EPR), a styrene-butadiene rubber (SBR), chloroprene, elastine, rubber epichlorohydrin, nylon, terpene, isoprene rubber, polybutadiene, nitrile rubber, thermoplastic elastomer, silicon, ethylene-propylene-diene rubber (EPDM), ethylene vinyl acetate (EVA), halogenated butyl rubber, neoprene, or a copolymer thereof.

Polyurethane may indicate a copolymer or a homopolymer with a urethane group. Silicon may also be referred to as a silicon rubber or a silicon resin and may indicate a copolymer or a homopolymer including silicon, and a fluorine polymer may indicate a copolymer or a homopolymer including fluorine.

The binder may include, e.g., polyether polyol and the polyether polyol may have a functionality of about 2 to about 4 and a number average molecular weight of about 2000 g/mol or more or about 4000 g/mol or less.

In an implementation, the binder may include poly ester polyol. The polyester polyol may be a condensation product in which low molecular polyol such as ethylene glycol, diethylene glycol, propylene glycol, butanediol, hexanediol, glycerine, trimethylolpropane, trimethylolethane, pentaerythritol, diglycerine, sorbitol, sucrose, or the like, and one such as succinic acid, sebacic acid, maleic acid, fumaric acid, phthalic acid, isophthalic acid, anhydrous succinic acid, maleic anhydride, anhydrous phthalic acid, or the like may be condensed. The polyester polyol may be a polyol which may be a ring-opening condensed product of caprolactone or methyl valerolactone classified as lactone ester. The polycarbonate polyol may be prepared by dealcoholization of a polyhydric alcohol such as ethylene glycol, diethylene glycol, propylene glycol, butanediol, pentanediol, hexanediol, or the like, or dialkyl carbonate, dialkylene carbonate, diphenyl carbonate, or the like. The polyester polyol may suitably have a functionality of about 2 to about 3 and a number average molecular weight of about 500 or more and about 1000 or less (or hydroxyl group of about 112 mg KOH/g or more and about 224 mg KOH/g or less).

In an implementation, the polyacrylate may be derived from C1 to C20 alkyl (meth)acrylate, hydroxy C1 to C20 alkyl (meth)acrylate, or a combination thereof.

Herein, the C1 to C20 indicates a carbon number of an alkyl group, e.g., C1 to C18, C1 to C15, C1 to C12, C1 to C10, C1 to C8, C1 to C5. The (meth)acrylate indicates acrylate or methacrylate.

The C1 to C20 alkyl (meth)acrylate may be, e.g., methyl (meth)acrylate, ethyl (meth)acrylate, propyl (meth)acrylate, butyl (meth)acrylate, 2-ethylhexyl (meth)acrylate, 2-ethylpentyl(meth)acrylate, 2-ethylheptyl(meth)acrylate, 2-ethylnonyl(meth)acrylate, 2-propylhexyl (meth)acrylate, 2-propyloctyl(meth)acrylate, or a combination thereof.

The hydroxy C1 to C20 alkyl (meth)acrylate may be, e.g., 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

In an implementation, the acrylate resin may be derived from C1 to C20 alkyl (meth)acrylate and hydroxy C1 to C20 alkyl (meth)acrylate, and the mixing ratio of C1 to C20 alkyl (meth)acrylate and hydroxy C1 to C20 alkyl (meth)acrylate may be about 20:80 to about 90:10 by weight ratio, e.g., about 30:70 to about 90:10, about 40:60 to about 90:10, about 60:40 to about 80:20 by weight ratio. In this case, the acrylate resin may exhibit appropriate adhesiveness and may be advantageous for achieving excellent compressive strength, a stress relaxation ratio, and a recovery ratio.

The acrylate resin may further include another repeating unit derived from acrylic acid, alkoxy-included acrylate or the like. The acrylate resin may have a weight average molecular weight of about 400,000 to about 2,000,000.

Based on the total weight of the elastic sheet, an amount of the binder may be, e.g., about 30 wt % to about 90 wt %, about 40 wt % to about 80 wt %, or about 50 wt % to about 70 wt %. If the amount of the binder is within the above ranges, it may be evenly distributed or mixed with the spherical polymer particles, and simultaneously uniformly relieve stress and pressurize.

The elastic sheet according to one or more embodiments may further include suitable additives in addition to the components. In an implementation, the additive may be, e.g., a cross-linking binder (e.g., silica, a polyisocyanate compound), a tackifier (terpene, phenol, or the like), or the like. Each additive may be included in a suitable amount according to the purpose.

In one or more embodiments, the thickness of the elastic sheet may be about 50 μm to about 800 μm, e.g., about 50 μm to about 600 μm, about 50 μm to about 500 μm, or about 150 μm to about 500 μm. If the thickness of the elastic sheet is within the above ranges, the stress due to pressurization and the stress due to the volume change during charging and discharging may be sufficiently relaxed and excellent restoring force may be exhibited.

### <Method of Preparing an Elastic Sheet>

A spherical polymer and a binder may be mixed in a solvent to prepare a composition for an elastic sheet. The solvent may be, e.g., toluene, benzene, or a combination thereof.

The composition for the elastic sheet may be coated on a substrate and photopolymerized (or photocured) or thermopolymerized (or thermocured) to prepare an elastic sheet. The substrate may be, e.g., a polyethylene terephthalate (PET) film.

The photopolymerization (or photocuring) may be carried out, e.g., by irradiating an ultraviolet ray with a light quantity of about 1,000 mJ/cm² to about 3,000 mJ/cm². In an implementation, a thermopolymerization (or thermocuring) may be carried out by heat-treating at about 70° C. to about 120° C.

### [All Solid-State Battery]

Another embodiment provides an all solid-state battery including the elastic sheet. The all solid-state battery may include a positive electrode, a negative electrode, a solid electrolyte layer between the positive electrode and the negative electrode, and the elastic sheet positioned outside of at least one of the positive electrode and the negative electrode.

The elastic sheet may be positioned on the outermost layer of an electrode assembly or may be also positioned on the outermost layer or inside the assembly in the structure in which at least two electrode assemblies may be stacked. Considering that thickness of the negative electrode may be significantly changed due to formation of dendrites, or the like during charge and discharge, the elastic sheet may be positioned on the outside of the negative electrode, e.g., on the opposite side of the surface where the solid electrolyte layer may be in contact with the negative electrode, thereby serving as a buffer and helping solve the shortcomings due to the changes in thickness. The elastic sheet may prevent the deterioration caused by the reaction with lithium by being positioned on the outside of the positive electrode or the negative electrode, so that the coulombic efficiency may be also enhanced.

### <Negative Electrode>

The negative electrode may include a current collector and a negative electrode layer on one side of the current collector.

The negative electrode layer may be a negative active material layer, or a negative electrode coating layer. In an implementation, the negative electrode layer may be a lithium metal layer.

In an implementation, the term “the negative electrode coating layer” may refer to a layer that may help the movement of lithium ions released from the positive active material to the negative electrode during charging and discharging of the all solid-state battery, thereby facilitating their deposition on the surface of the current collector. In an implementation, a lithium-containing layer, e.g., a lithium deposition layer, due to the deposition of lithium ions between the current collector and the negative electrode coating layer may be formed, and the lithium deposition layer may act as a negative active material. This negative electrode may generally refer to a deposition-type negative electrode. The metal and amorphous carbon included in the negative electrode coating layer may not act as a negative active material which directly participates in the charge and discharge reaction. Such a deposition-type negative electrode may represent a negative electrode that does not include a negative active material during the battery preparation, but the lithium-included layer may act as a negative active material.

The lithium-containing layer may be formed between the negative electrode current collector and the negative electrode coating layer.

The negative electrode coating layer may include a metal, a carbon material, or combination thereof which may serve as a catalyst. In the negative electrode coating layer, e.g., a metal may be supported on a carbonaceous material, or a metal and a carbonaceous material may be mixed together. In an implementation, the negative electrode coating layer may include the metal and the carbon material.

The carbonaceous material may be, e.g., crystalline carbon, amorphous carbon, or a combination thereof, and in some embodiments, may be amorphous carbon. The crystalline carbon may be, e.g. natural graphite, artificial graphite, mesophase carbon microbead, carbon nanotube, graphene, or a combination thereof. The crystalline carbon may have an unspecified shape, a sheet shape, a flake shape, a spherical shape, or a fiber shape. The amorphous carbon may be, e.g., carbon black, acetylene black, Denka Black, Ketjen black, furnace black, activated carbon, graphene, or combinations thereof. The carbon black may be Super P (available from Timcal, Ltd.).

In an implementation, the carbon material may be, e.g., single particles, a secondary particle in which a plurality of primary particles may be agglomerated, or combinations thereof.

If the carbon material is single particles, the size of the carbon material may have an average particle diameter of about 100 nm or less, e.g., about 10 nm to about 100 nm.

If the carbon material is an agglomerated product, the particle diameter of the primary particle may be about 20 nm to about 100 nm and the particle diameter of the secondary particle may be about 1 μm to about 20 μm.

In an implementation, a particle diameter of the primary particles may be, e.g., about 20 nm to about 100 nm, about 20 nm to about 90 nm, about 20 nm to about 80 nm, or about 30 nm to about 70 nm.

In an implementation, a particle diameter of the secondary particle may be, e.g., about 1 μm to about 20 μm, about 2 μm to about 15 μm, or about 3 μm to about 10 μm.

The shape of the primary particle may be spherical, oval, plate-shaped, or combinations thereof. In an implementation, the shape of the primary particle may be spherical, oval, or combinations thereof.

The metal may be, e.g., Ag, Au, Sn, Zn, Al, Mg, Ge, Cu, In, Ni, Bi, Pt, Pd, or a combination thereof. The inclusion of the metal in the negative electrode coating layer may further improve the electrical conductivity of the negative electrode.

The metal may be nano particles and the size of the metal nano particles, an average size, may be, e.g., about 5 nm to about 800 nm, about 5 nm to about 700 nm, about 5 nm to about 500 nm, or about 5 nm to about 300 nm. However, it may be limited thereto, if it is nanosized, it may be appropriately used. If the metal nanoparticles are used, the battery characteristics, e.g., cycle-life characteristics of the all solid-state battery, may be improved. If the size of the metal particles are increased to micrometer size, the uniformity of the metal particles may be reduced in the negative electrode coating layer, and thus, a current density may be increased at a specific region, thereby deteriorating the cycle-life characteristics.

In an implementation, if the negative coating layer may include a mixture of the metal and the carbon material, an amount of the metal may be, e.g., about 1 wt % to about 40 wt %, about 3 wt % to about 30 wt %, about 4 wt % to about 25 wt %, about 5 wt % to about 20 wt %, or about 5 wt % to about 15 wt %, based on a total weight of the mixture of the metal and the carbon material.

The amount of the carbon material may be, e.g., about 60 wt % to about 99 wt %, about 70 wt % to about 97 wt %, about 75 wt % to about 96 wt %, about 80 wt % to about 95 wt %, or about 85 wt % to about 95 wt %, based on the total weight of the mixture of the metal and the carbon material.

The negative electrode coating layer may further include a binder. The binder may include a non-aqueous binder.

The aqueous binder may include, e.g., polyvinyl chloride, carboxylated polyvinyl chloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamide imide, polyimides, polyacrylate, or a combination thereof.

An amount of the binder may include, e.g., about 1 wt % to about 15 wt % based on a total weight of the negative electrode coating layer. In an implementation, an amount of the binder may be, e.g., about 1 wt % to about 14 wt %, about 1 wt % to about 12 wt %, about 1 wt % to about 10 wt %, about 2 wt % to about 8, or about 2 wt % to about 7 wt % based on the total weight of the negative electrode coating layer.

If the binder is included in the negative electrode coating layer of the all solid-state battery in the above weight ranges, the electrical resistance and the adherence may be improved, thereby enhancing the characteristics of the all solid-state battery (battery capacity and power characteristics).

The negative electrode coating layer may further include a solid electrolyte, and the solid electrolyte may be, e.g., an inorganic solid electrolyte such as a sulfide solid electrolyte, an oxide solid electrolyte, a halide solid electrolyte, or the like, or a solid polymer electrolyte.

In one or more embodiments, the sulfide solid electrolyte may be Li₂S—P₂S₅, Li₂S—P₂S₅—LiX (where X may be an halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n may each be an integer of about 0 or more or about 12 or less, Z may be, e.g., Ge, Zn, or Ga), Li₂S—GeS₂, Li₂S—SiS₂—Li₃PO₄, Li₂S—SiS₂-LiₚMO_{q} (where p and q may each be an integer of about 0 or more or about 12 or less and M may be, e.g., P, Si, Ge, B, Al, Ga, or In), LiₐM_{b}P_{c}S_{d}Aₑ (where a, b, c, d, and e may each be an integer of about 0 or more or about 12 or less, M may be, e.g., Ge, Sn, Si, or a combination thereof, and A may be, e.g., F, Cl, Br, or I). The sulfide solid electrolyte may be, e.g., Li₇₋ₓPS₆₋ₓFₓ (0≤x≤2), Li₇₋ₓPS₆₋ₓClₓ (0≤x≤2), Li₇₋ₓPS₆₋ₓBrₓ (0≤x≤2) or Li₇₋ₓPS₆₋ₓIₓ (0≤x≤2). In an implementation, the sulfide solid electrolyte may be Li₃PS₄, Li₇P₃S₁₁, Li₇PS₆, Li₆PS₅Cl, Li₆PS₅Cl, Li₆PS₅I, Li₆PS₅Br, Li_{5.8}PS_{4.8}Cl_{1.2}, Li_{6.2}PS_{5.2}Br_{0.8}, or the like.

In one or more embodiments, the sulfide solid electrolyte may be an argyrodite-type sulfide solid electrolyte. The argyrodite-type sulfide solid electrolyte may be, e.g., LiₐM_{b}P_{c}S_{d}Aₑ (where a, b, c, d, and e may each be an integer of about 0 or more or about 12 or less, M may be Ge, Sn, Si, or a combination thereof, and A may be F, Cl, Br, or I).

In an implementation, the sulfide solid electrolyte may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.02}S)Cl_{1.25}, Li_{5.75}P(S_{4.725}(SO₄)_{0.025})Cl_{1.25}, or a combination thereof.

The sulfide solid electrolyte may be, e.g., amorphous, crystalline, or a combination thereof. The sulfide solid electrolyte may be prepared, e.g., by mixing Li₂S and P₂S₅ at a mole ratio of about 50:50 to about 90:10, or about 50:50 to about 80:20. In the above ranges of mixing ratios, a sulfide solid electrolyte exhibiting excellent ionic conductivity may be prepared. As other components, SiS₂, GeS₂, B₂S₃, or the like may be further included thereto, thereby further improving ionic conductivity.

The mixing procedure of the sulfur-included source for preparing the sulfide solid electrolyte may be performed, e.g., by a mechanical milling or a solution method. The mechanical milling may be performed by adding starting raw material, a ball mill, or the like, in a reactor and vigorously stirring to pulverize the starting raw material and to mix them together. The solution method may provide a solid electrolyte as a precipitate by mixing starting raw material in a solvent. If the heat treatment is performed after mixing, the crystal of the solid electrolyte may be further solidified and ionic conductivity may be further improved. In an implementation, the sulfide solid electrolyte may be prepared by mixing sulfur-included raw materials and heat-treating them twice or more, which may provide a sulfide solid electrolyte with high ionic conductivity and rigidity. The sulfide solid electrolyte may be a commercial solid electrolyte.

The oxide inorganic solid electrolyte may be, e.g., Li₁₊ₓTi₂₋ₓAl PO₄₃(LTAP) (0≤x<Δ), Li_{1+x+y}AlₓTi₂₋ₓSi_{y}P_{3-y}O₁₂ (0<x<2, 0≤y≤3), BaTiO₃, Pb(Zr,Ti)O₃(PZT), Pb₁₋ₓLaₓZr_{1-y}Ti_{y}O₃(PLZT) (0 x<1, 0≤y≤1), Pb(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics, Li₃₊ₓLa₃M₂O₁₂ (where M=Te, Nb, or Zr, and x may be an integer of about 1 to about 10), or a mixture thereof.

The solid polymer electrolyte may include, e.g., polyethylene oxide, poly(diallyldimethyl ammonium)trifluoromethanesulfonylimide (TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ(PO₄)₃(0.1≤x≤0.9), Li₁₊ₓHf₂₋ₓAlₓ(PO₄)₃(0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂(where M may be a rare earth element such as Nd, Gd, Dy, or the like) Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti)₂₋ₓ(PO₄)₃ (0≤x≤0.8, 0≤y≤1.0, M may be Nd, Sm, Eu, Gd, Tb, Dy, Ho, Er, Tm, or Yb), Li_{1+x+y}QₓTi₂₋ₓSi_{y}P_{3-y}O₁₂ (0≤x≤0.4, 0≤y≤0.6, Q may be Al or Ga), Li₆BaLa₂Ta₂O₁₂, Li₇La₃Zr₂O₁₂, Li₅La₃Nb₂O₁₂, Li₅La₃M₂O₁₂ (where M may be Nb or Ta) and Li₇₊ₓAₓLa₃₋ₓZr₂O₁₂ (0<x<3 and A may be Zn).

The halide solid electrolyte may include a Li element, a M element (where M may be any metal except for Li), and a X element (where X may be a halogen). X may be, e.g., F, Cl, Br and I. In an implementation, the halide solid electrolyte may include at least one of Br and Cl, as the X. The M may be, e.g., a metal element such as Sc, Y, B, Al, Ga, In, or the like.

The halide solid electrolyte may be represented by Li₆₋₃ₐMₐBr_{b}Cl_{c} (where M may be any metal, except for Li, 0<a<2, 0≤b≤6, 0≤c≤6, b+c=6). The a may be about 0.75 or more, or about 1 or more, or the a may be about 1.5 or less. The b may be about 1 or more, or about 2 or more. The c may be about 3 or more, or about 4 or more. In an implementation, the halide solid electrolyte may be Li₃YBr₆, Li₃YCl₆ or Li₃YBr₂Cl₄.

The negative catalyst layer may further include, e.g., additives such as a filler, a dispersing agent, an ionic conductive material, or the like. As the filler, the dispersing agent, the ionic conductive material included in the negative coating layer, a well-known material generally used for the all solid-state battery may be used.

A thickness of the negative electrode coating layer may be, e.g., about 1 μm to about 500 μm, about 1 μm to about 200 μm, about 1 μm to about 100 μm, or about 1 μm to about 50 μm.

The current collector may be, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the current collector may be about 1 μm to 20 μm, about 5 μm to about 15 μm, or about 7 μm to about 10 μm.

The current collector may include the metal as a substrate and may further include a thin membrane on the substrate. The thin membrane may include an element being capable of forming an alloy with lithium, e.g., gold, silver, zinc, tin, indium, silicon, aluminum, bismuth, or a combination thereof. Any element capable of forming an alloy with lithium may be used. If the current collector further includes a thin membrane, a more flattened lithium-containing layer may be formed if the lithium is deposited during charging to form the lithium-containing layer, thereby further improving the cycle-life characteristics of the all solid-state battery.

A thickness of the thin membrane may be about 1 nm to about 800 nm, about 10 nm to about 700 nm, about 50 nm to about 600 nm, or about 100 nm to about 500 nm. If the thickness of the thin membrane is within the above ranges, the cycle-life characteristics may be further enhanced.

The negative electrode in an implementation may further include a lithium-containing layer between the current collector and the negative electrode coating layer at the initial charge after the battery preparation. In an implementation, the thickness of the lithium-containing layer may be about 1 μm to about 1000 μm, about 1 μm to about 500 μm, about 1 μm to about 200 μm, about 1 μm to about 150 μm, about 1 μm to about 100 μm, or about 1 μm to about 50 μm. If the thickness of the lithium-containing layer is within the above ranges, it may effectively perform the role of a lithium reservoir and the cycle-life characteristics may be further enhanced.

The lithium-containing layer may be formed by releasing lithium ions from a positive active material, passing through the solid electrolyte and moving to the negative electrode, and thus, it may be participated and deposited on the negative current collector, after fabricating the battery.

The charging may be a formation process which may be performed at 0.05 C to 1 C at about 25° C. to about 50° C. once to three times. If lithium is participated and deposited to form the lithium-containing layer, lithium included in the lithium-containing layer may be ionized during discharging to move to the positive direction, and thus, this lithium may be used as a negative active material.

In one or more embodiments, as the lithium-containing layer may be positioned between the current collector and the negative electrode coating layer, the negative electrode coating layer may serve as a protecting layer for the lithium-containing layer, and thus, the deposition growth of lithium dendrite may be suppressed. This may help inhibit capacity fading and short-circuiting of the all solid-state battery and resultantly may help improve the cycle-life of the all solid-state battery.

The negative active material layer may include a negative active material and may include a binder, and optionally may further include a conductive material.

The negative active material may include a material capable of reversibly intercalating/deintercalating lithium-ion, a lithium metal, an alloy of lithium metal, a material capable of doping and dedoping lithium, or a transition metal oxide.

The material capable of reversibly intercalating/deintercalating the lithium-ion may be a carbon negative active material, and, e.g., may be crystalline carbon, amorphous carbon, or a combination thereof. The crystalline carbon may be graphite such as unspecified shape, sheet, flake, spherical or fiber shaped natural graphite or artificial graphite, and the amorphous carbon may be soft carbon, hard carbon, mesophase pitch carbide, sintered cokes, or the like. Lithium, and a metal alloy, e.g., Na, K, Rb, Cs, Fr, Be, Mg, Ca, Sr, Si, Sb, Pb, In, Zn, Ba, Ra, Ge, Al, or Sn may be used as the alloy of the lithium metal.

Examples of the material capable of doping and dedoping lithium may include a Si negative active material or a Sn active material, and the Si negative active material may be Si, Si—C composite, SiOₓ (0<x<2), Si-Q alloys (where Q may be, e.g., an alkali metal, an alkali-earth metal, a group 13 element, a group 14 element, a group 15 element, a group 16 element, a transition metal, a rare earth element, or a combination thereof, but Q may not be Si), and the Sₙ negative active material may be, e.g., Sₙ, SnO₂, and Sn—R (where R may be, e.g., an alkali metal, an alkaline earth metal, a group 13 element, a group 14 element, a group 15 element, a group 16 element, a transition metal, a rare earth element, or combinations thereof, but R may not be Sₙ), or the like. At least one of these materials may be mixed with SiO₂. The elements Q and R may be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or combinations thereof.

The silicon-carbon composite may be, e.g., silicon particles and an amorphous carbon coating layer on the surface of the silicon particles. In an implementation, the Si—C composite may include secondary particles where silicon primary particles may be agglomerated and an amorphous carbon coating layer on the surface of the secondary particles. The amorphous carbon may be positioned between the silicon primary particles, e.g., the silicon primary particles may be coated with an amorphous carbon coating layer. The Si—C composite may include a core where silicon particles may be distributed in an amorphous carbon matrix and an amorphous carbon coating layer coated on the surface of the core.

The silicon primary particles may be nano silicon particles. A particle diameter of the nano silicon particles may be about 10 nm to about 1,000 nm, and in an implementation, may be about 20 nm to about 900 nm, about 20 nm to about 800 nm, about 20 nm to about 500 nm, about 20 nm to about 300 nm, or about 20 nm to about 150 nm. If the average diameter of the silicon nano particle is within the above ranges, the excessive volume expansion caused during charge and discharge may be suppressed, and breakage of the conductive path due to particle crushing may be prevented.

If the Si—C composite includes the silicon particles and the amorphous carbon coating layer, based on the total weight of the silicon-carbon composite, an amount of the silicon particles may be about 30 wt % to about 70 wt %, or about 40 wt % to about 65 wt %. An amount of the amorphous carbon coating layer may be, based on the total weight of the silicon-carbon composite, about 30 wt % to about 70 wt % or about 35 wt % to about 60 wt %.

The Si—C composite may further include crystalline carbon. If the Si—C composite further includes crystalline carbon, it may include an agglomerated product where silicon particles and crystalline carbon may be agglomerated, and an amorphous carbon coating layer on the surface of the agglomerated product.

If the Si—C composite further includes crystalline carbon, based on the total weight of the Si—C composite, an amount of the silicon nano particles may be about 20 wt % to about 70 wt %, or about 25 wt % to about 65 wt %. Based on the total weight of the Si—C composite, an amount of the amorphous carbon may be about 25 wt % to about 70 wt % or about 25 wt % to about 60 wt % and an amount of crystalline carbon may be about 1 wt % to about 20 wt %, or about 5 wt % to about 15 wt %. The particle diameter of the Si—C composite may be appropriately adjusted.

The thickness of the amorphous carbon coating layer may be appropriately adjusted but may be, e.g., about 5 nm to about 100 nm.

An average particle diameter (D50) of the silicon particle may be about 10 nm to about 20 μm, or about 10 nm to about 500 nm. The silicon particle may be presented in an oxidized form and an atomic weight ratio of Si:O representing a degree of oxidation may be about 99:1 to about 33:67. The silicon particle may be SiOₓ particles and in SiOₓ, a range for x may be more than about 0 and less than about 2. As used herein, an average particle diameter D₅₀ indicates a diameter of particle where the cumulative volume corresponds to about 50 volume % in the particle size distribution, as measured by a particle size analyzer using a laser diffraction method.

The Si negative active material or the Sn negative active material may be mixed with the carbon negative active material. A mixing ratio of the Si negative active material or the Sn negative active material, and the carbon negative active material may be a weight ratio of about 1:99 to about 90:10.

In the negative active material layer, an amount of the negative active material may be about 95 wt % to about 99 wt % based on the total weight of the negative active material layer.

In the negative active material layer, an amount of the binder may be about 1 wt % to about 5 wt % based on the total weight of the negative active material layer. In the case of further including the conductive material, the negative active material may be included in an amount of about 90 wt % to about 98 wt %, based on the total weight of the negative active material layer, the binder may be included in an amount of about 1 wt % to about 5 wt %, based on the total weight of the negative active material layer, and the conductive material may be included at an amount of about 1 wt % to about 5 wt %, based on the total weight of the negative active material layer.

The binder may help improve binding properties of negative active material particles with one another and with a current collector. The binder may include a non-aqueous binder, an aqueous binder, or a combination thereof.

The non-aqueous binder may include polyvinylchloride, carboxylated polyvinylchloride, polyvinyl fluoride, polyethylene oxide, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The aqueous binder may include a styrene-butadiene rubber, an acrylated styrene-butadiene rubber, an acrylonitrile-butadiene rubber, an acrylic rubber, a butyl rubber, a fluorine rubber, polyvinyl pyrrolidone, polyepichlorohydrin, polyphosphazene, polyacrylonitrile, an ethylene propylenediene copolymer, polyvinyl pyridine, chlorosulfonated polyethylene, latex, a polyester resin, an acrylic resin, a phenolic resin, an epoxy resin, polyvinyl alcohol, or combinations thereof.

As the negative electrode binder, a cellulose compound may be used. The cellulose compound and the aqueous binder may be used together therewith. The cellulose compound may include, e.g., carboxymethyl cellulose, hydroxypropylmethyl cellulose, methyl cellulose, or alkali metal salts thereof. The alkali metal may be, e.g., Na, K, or Li. The cellulose compound may serve as a binder and may serve as a thickener to impart viscosity. In an implementation, the amount of the cellulose compound may be, e.g., about 0.1 parts by weight to about 3 parts by weight based on 100 parts by weight of the negative active material.

The conductive material may be included to provide electrode conductivity. Examples of the conductive material may be a carbon material such as natural graphite, artificial graphite, carbon black, acetylene black, Ketjen black, carbon fiber, carbon nanotube, or the like; a metal material of a metal powder or a metal fiber including copper, nickel, aluminum, silver, or the like; a conductive polymer such as polyphenylene derivatives; or mixtures thereof.

The negative electrode current collector may include, e.g., a copper foil, a nickel foil, a stainless steel foil, a titanium foil, a nickel foam, a copper foam, a polymer substrate coated with a conductive metal, or a combination thereof.

### <Positive Electrode>

The positive electrode may include a positive current collector and a positive active material layer on the positive current collector.

The positive active material layer may include a positive active material. The positive active material may include compounds that reversibly intercalate and deintercalate lithium ions. In an implementation, it may include one or more composite oxides of a metal, e.g., cobalt, manganese, nickel, or a combination thereof, and lithium. The examples of the positive active material may be, e.g., LiₐA_{1.b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c}(0.90≤a≤1.8, 0≤b≤0.5, 0≤c≤05); LiₐNi_{1-b-c}Co_{b}B¹_{c}D¹_{α}. (0.90≤a≤1.8, 0≤b≤0.5, 0≤c≤0.5, 0≤α≤2); LiₐNi_{1-b-c}Co_{b}B¹_{c}O_{2-α}F¹_{α} (0.90≤a≤1.8, 0≤b≤0.5, 0≤c≤0.5, 0≤α≤2); LiₐNi_{1-b-c}Co_{b}B¹_{c}O_{2-α}F¹_{α} (0.90≤a≤1.8, 0≤b≤0.5, 0≤c≤0.5, 0≤α≤2); LiₐNi_{1-b-c}Mn_{b}B¹_{c}D¹_{α} (0.90≤a≤1.8, 0≤b≤0.5, 0≤c≤0.5, 0≤α≤2); LiₐNi_{1-b-c}Mn_{b}B¹_{c}O_{2-α}F¹_{α}, (0.90≤a≤1.8, 0≤b≤0.5, 0≤c≤0.5, 0≤a≤2); LiₐNi_{1-b-c}Mn_{b}B¹_{c}O_{2-α}F¹₂ (0.90≤a≤1.8, 0≤b≤0.5, Oc≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃(0≤f≤2); Li_{(3-f)}Fe₂(PO₄)₃(0≤f≤2); or LiFePO₄.

In the chemical formulas A may be, e.g., Co, Mn, or a combination thereof, B¹ may be, e.g., Al, Ni, Co, Mn, Cr, Fe, Mg, Sr, V, a rare earth element, or a combination thereof, D1 may be, e.g., O, F, S, P, or combination thereof, E may be, e.g., Co, Mn, or combination thereof, F¹ may be F, S, P, or a combination thereof, G may be, e.g., Al, Cr, Mn, Fe, Mg, La, Ce, Sr, V, or a combination thereof, Q may be, e.g., Ti, Mo, Mn, or a combination thereof, I¹ may be, e.g., Cr, V, Fe, Sc, Y, or a combination thereof, J may be, e.g., V, Cr, Mn, Co, Ni, Cu, or a combination thereof, L¹ may be, e.g., Mn, Al, or a combination thereof.

In an implementation, the positive active material may be a three-component lithium transition metal oxide such as LiNixCoyAlzO2 (NCA) or LiNixCoyMnzO2 (NCM) (wherein, 0<x<1, 0<y<1, 0<z<1, x+y+z=1).

The compounds may have a coating layer on the surface or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be provided by a method having no (or substantially no) adverse influence on properties of a positive active material by using these elements in the compound. In an implementation, the method may include any suitable coating method such as spray coating, dipping, or the like, but is not illustrated in more detail because it should be readily recognizable to those of ordinary skill in the art upon reviewing the present disclosure.

Furthermore, the coating layer may be any coating material which may be known as a coating layer for the positive active material of the all solid battery. In an implementation, it may be a buffer layer which serves to reduce an interface resistance of the positive active material and the solid electrolyte. In an implementation, the buffer layer may include lithium-metal-oxide and this metal may be, e.g., Al, B, Ca, Ce, Cr, Fe, Mg, Mo, Nb, Si, Sn, Sr, Ta, V, W, or Zr. In an implementation, the buffer layer may be Li2O—ZrO2 (LZO), or the like.

If the positive active material is three-components including nickel, cobalt, and manganese, or nickel, cobalt, and aluminum, the capacity density of the all solid-state battery may be further improved, the metal elution from the positive active material at charged state may be further reduced. This may further improve long reliability and cycle characteristics of the all solid-state battery at charged state.

The average particle diameter of the positive active material may be, e.g., about 1 μm to about 25 μm, about 3 μm to about 25 μm, about 1 μm to about 20 μm, about 1 μm to about 18 μm, about 3 μm to about 15 μm, or about 5 μm to about 15 μm. In an implementation, the positive active material may include small particles with an average particle diameter D50 of about 1 μm to about 9 μm and large particles with an average particle diameter D50 of about 10 μm to about 25 μm. The positive active material with a particle diameter range may be harmoniously mixed with other components in the positive active material layer and may achieve high capacity and high energy density.

The positive active material may include secondary particles where a plurality of primary particles may be agglomerated, or monocrystalline (single crystal). The shape of the positive active material may be, e.g., a spherical shape, a shape close to spherical, or a particle shape such as polyhedron, or a unspecified shape, or the like.

In the positive active material layer, an amount of the positive active material may be in any range which may be applied to a positive electrode layer of the conventional all solid-state secondary battery. In an implementation, based on the total weight of the positive active material layer, the positive active material may be included in about 55 wt % to about 99.5 wt %, e.g., about 65 wt % to about 95 wt %, or about 75 wt % to about 91 wt %.

The positive active material layer may further include a binder or a conductive material.

The binder may include, e.g., polyvinyl alcohol, carboxymethyl cellulose, hydroxypropyl cellulose, diacetyl cellulose, polyvinylchloride, carboxylated polyvinylchloride, polyvinyl fluoride, polyethylene oxide, polyvinylpyrrolidone, polyurethane, polytetrafluoroethylene, polyvinylidene fluoride, polyvinylidene fluoride-hexafluoropropylene, polyethylene, polypropylene, styrene-butadiene rubber, an acrylated styrene-butadiene rubber, epoxy resin, nylon, or the like.

The binder may be included in an amount of about 0.1 wt % to about 5 wt %, or about 0.1 wt % to about 3 wt % based on a total weight of the positive active material layer. In the above ranges, the adhesion ability may be sufficiently secured without deteriorating the battery performance.

The conductive material may be included to provide electrode conductivity. Any electrically conductive material may be used as a conductive material unless it causes a chemical change. Examples of the conductive material may include, e.g., a carbon material such as natural graphite, artificial graphite, carbon black, acetylene black, Ketjen black, carbon fiber, carbon nanofiber, carbon nanotube or the like; a metal material of a metal powder or a metal fiber including copper, nickel, aluminum, silver, or the like; a conductive polymer such as polyphenylene derivatives; or mixtures thereof.

The conductive material may be included in an amount of about 0.1 wt % to about 5 wt %, or about 0.1 wt % to about 3 wt % based on the total weight of the positive active material layer. The conductive material in the above ranges may improve the electrical conductivity without deteriorating battery performance.

The positive active material layer may further include a solid electrolyte. The solid electrolyte included in the positive active material layer may be, e.g., an inorganic solid electrolyte such as a sulfide solid electrolyte, an oxide solid electrolyte, a halide solid electrolyte, or the like, or a solid polymer electrolyte. The solid electrolyte included in the positive electrode may be the same as or different from the solid electrolyte included in the negative electrode.

Based on the total weight of the positive active material layer, the solid electrolyte may be included in an amount of about 0.1 wt % about to 35 wt %, e.g., about 1 wt % to about 35 wt %, about 5 wt % to about 30 wt %, about 8 wt % to about 25 wt %, or about 10 wt % to about 20 wt %. In the positive active material layer, based on the total weight of the positive active material and the solid electrolyte, the positive active material may be included in an amount of about 65 wt % to about 99 wt % and the solid electrolyte may be included in an amount of about 1 wt % to about 35 wt %, e.g., the positive active material may be included in an amount of about 80 wt % to about 90 wt % and the solid electrolyte may be included in an amount of about 10 wt % to about 20 wt %. If the solid electrolyte with amounts in the above ranges is included in the positive electrode, the efficiency and cycle-life characteristic of the all solid-state battery may be improved, without deterioration of capacity.

The positive current collector may be, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

### <Solid Electrolyte Layer>

The solid electrolyte layer may include a solid electrolyte. The solid electrolyte may be an inorganic solid electrolyte such as a sulfide solid electrolyte, an oxide solid electrolyte, a halide solid electrolyte, or the like, or a solid polymer electrolyte.

In one or more embodiments, the inorganic solid electrolyte such as the sulfide solid electrolyte, the sulfide solid electrolyte, the oxide solid electrolyte, the halide solid electrolyte, or the solid polymer electrolyte may be as described above.

The solid electrolyte may have a particle shape and may have an average particle diameter D50 of about 5.0 μm or less, e.g., about 0.1 μm to 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm.

The solid electrolyte layer may further include a binder. The binder may include a styrene butadiene rubber, polytetrafluoroethylene, polyvinylidene fluoride, polyethylene, an acrylate polymer, or a combination thereof, and may be any material which may be generally used in the related art. The acrylate polymer may be butyl acrylate, polyacrylate, polymethacrylate, or a combination thereof.

The solid electrolyte layer may be prepared by adding a solid electrolyte to a binder solution, coating it on a substrate film, and drying it. The binder solution may include isobutyl isobutyrate, xylene, toluene, benzene, hexane, or a combination thereof, as a solvent. The solid electrolyte layer preparation is widely known in the art, so a detailed description thereof will be omitted in the specification.

The solid electrolyte layer may further include an alkali metal salt, or an ionic liquid, or a conductive polymer.

The alkali metal salt may be, e.g., a lithium salt. In the solid electrolyte layer, an amount of the lithium salt may be about 1 M or more, e.g. about 1 M to about 4 M. In the above ranges, the lithium salt may improve the lithium ion mobility of the solid electrolyte layer, thereby improving ionic conductivity.

The lithium salt, may be, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃C₂F₅, lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

The lithium salt may be an imide, e.g., the imide lithium salt may be lithium bis(trifluoro methanesulfonyl)imide (LiTFSI, LiN(SO₂CF₃)₂) or lithium bis(fluorosulfonyl)imide (LiFSI, or LiN(SO₂F)₂). The lithium salt may suitably maintain the chemical reactivity with the ionic liquid, and thus, the ionic conductivity may be maintained or improved.

The ionic liquid may have a melting point at ambient temperature or less and may be in a liquid state at ambient temperature and may include salts consisting of ions, or ambient temperature molten salts.

The ionic liquid may be a compound including a) a cation, e.g., ammonium, pyrrolidinium, pyridinium, pyrrimidinium, imidazolium, piperridinium, pyrazolium, oxazolium, pyridazinium, phosphonium, sulfonium, triazolium, or a mixture thereof, and b) an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br, I⁻, BF₄⁻, SO₄⁻, CF₃SO₃⁻, FSO₂₂N⁻, (C₂F₅SO₂)₂N⁻, (C₂F₅SO₂, CF₃SO₂)N⁻, or (CF₃SO₂)₂N⁻.

The ionic liquid may be, e.g., N-methyl-N-propyl pyrrolidinium bis(trifluoromethanesulfonyl)imide, N-butyl-N-methylpyrroleridium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

In the solid electrolyte layer, the weight ratio of the solid electrolyte and the ionic liquid may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer within the above ranges may have an improved electrochemical contact area to the electrode, and thus, the ionic conductivity may be maintained or improved. This may help improve the energy density, discharge capacity, rate capability, or the like of the all solid-state battery.

The all solid-state battery may be an unit battery including a structure of the positive electrode/the solid electrolyte layer/the negative electrode, a bicell including a structure of the positive electrode/the solid electrolyte layer/the negative electrode/the solid electrolyte layer/the positive electrode, or a stacked battery where the unit batteries may be repeated.

The shape of the all solid-state battery may be, e.g., a coin-type, a button-type, a sheet-type, a laminate-type, a cylindrical-type, or a flat-type, or the like. The all solid-state battery may be applied to medium to large batteries used in electric vehicles. In an implementation the all solid-state battery may be also used in hybrid vehicles such a plug-in hybrid electric vehicle (PHEV), or the like. It may be applied to areas where a large amount of power storage may be required, e.g., it may also be applied to electric bicycles or power tools. Furthermore, the all solid-state rechargeable battery may be used in various fields such as portable electronic devices.

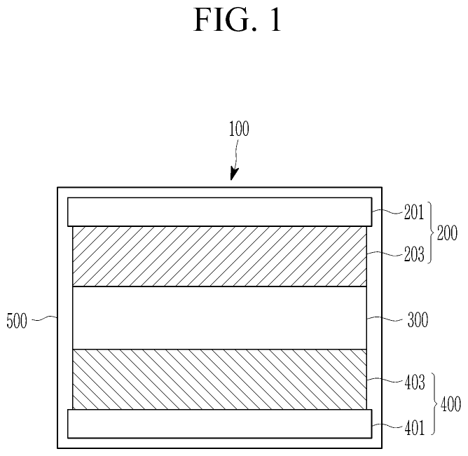

FIG. 1 is a cross-sectional view showing the all solid-state battery according to embodiments. Referring to FIG. 1, the all solid-state battery 100 may have a structure in which an electrode assembly may be stacked with a negative electrode 400 including a negative current collector 401 and a negative coating layer 403, a solid electrolyte layer 300, a positive electrode 200 including a positive current collector 201 and a positive active material layer 203, may be housed in a case such as a pouch, or the like. The all solid-state battery 100 may further include an elastic layer 500 positioned on the outside of at least one of the positive electrode 200 or the negative electrode 400. FIG. 1 shows one electrode assembly including a negative electrode 400, a solid electrolyte layer 300, and a positive electrode 200, but it may be an all solid-state battery fabricated by stacking at least two electrode assemblies.

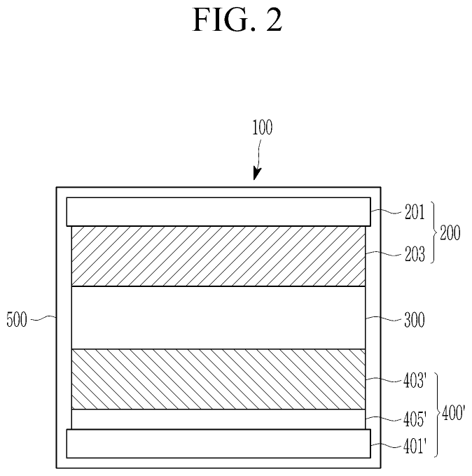

FIG. 2 is a schematic cross-sectional view of the all solid-state battery of one or more embodiments. The all solid-state battery 100 shown in FIG. 2 may include a positive electrode 200 including a positive current collector 201 and a positive active material layer 203, a negative electrode 400′ including a negative electrode current collector 401′ and a negative electrode coating layer 403′, a solid electrolyte 300 between the positive electrode 200 and the negative electrode 400′, a battery case 500 in which these may be housed, and a lithium deposition layer 405′ between the negative current collector 401′ and the negative coating layer 403′. Such a lithium deposition layer may be formed by releasing lithium ions from the positive electrode to deposit on the negative current collector 401′ during charging.

The all solid-state battery according to an implementation may be fabricated by sequentially stacking the positive electrode, the negative electrode and the solid electrolyte layer between the positive electrode and the negative electrode to prepare an assembly and pressurizing the assembly.

The pressurization may be carried out at a temperature of about 25° C. to about 90° C. The pressurization may be carried out under a pressure of about 550 MPa. In an implementation, the pressurization may be carried out under a pressure of about 500 MPa or less, e.g., a pressure of about 1 MPa to about 500 MPa. The pressurization time may be varied depending on the temperature and pressure, e.g., it may be less than about 30 minutes. The pressurization may be achieved, e.g., through an isostatic press, a warm isostatic press, a roll press, or a plate press.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Preparation of Elastic Sheet

50 wt % of a polyethylene spherical polymer having a sphericity of 0.9 (average particle diameter D50: 4 m) and 50 wt % of a polyether polyol binder were mixed in a toluene solvent to prepare a composition for an elastic sheet.

The resulting composition was coated on a polyethylene terephthalate (PET) film as a release film and was irradiated with ultraviolet (UV) with a light quantity of 2000 mJ/cm² to prepare an elastic sheet adhered on the PET film.

### (2) Preparation of Negative Electrode

Carbon black with an average particle diameter D50 of approximately 30 nm and silver (Ag) with an average particle diameter D50 of approximately 60 nm were mixed at a weight ratio of 3:1, 0.25g of the mixture was added to 2 g of an N-methyl pyrrolidone solution including 7 wt % of polyvinylidene fluoride binder, and then mixed to prepare a composition for a negative active material layer.

The composition for the negative active material layer was coated on a nickel foil current collector using a bar coater and vacuum-dried to prepare a negative electrode.

### (2) Preparation of Positive Electrode

85 wt % of a LiNi_{0.8}Co_{0.15}Mn_{0.05}O₂ positive active material, 13.5 wt % of a lithium agyrodite-type solid electrolyte Li₆PS₅Cl, 1.0 wt % of a polyvinylidene fluoride binder, and 0.5 wt % of a carbon nanotube conductive material were mixed in an N-methyl pyrrolidone solvent to prepare a positive electrode composition.

The prepared positive electrode composition was coated on an aluminum positive current collector using a bar coater, and dried followed by pressurizing to prepare a positive electrode.

### (3) Preparation of Solid Electrolyte Layer

To an argyrodite-type solid electrolyte Li₆PS₅Cl, a binder solution (solid amount: 50 wt %) in which butyl acrylate as an acrylate polymer was added to isobutyl isobutyrate was added and then mixed. A mixing ratio of the solid electrolyte and the binder was set to be a weight ratio of 98.7:1.3.

The mixing process was carried out using a Thinky mixer. The mixture was added with a 2 mm zirconia ball and was repeatedly agitated using a Thinky mixer to prepare a slurry. The slurry was cast on a release polytetrafluoroethylene film and dried at ambient temperature to prepare a solid electrolyte layer with a thickness of 100 μm.

### (4) Fabrication of all Solid-State Cell

The prepared positive electrode, the solid electrolyte layer, and the negative electrode were sequentially stacked, and then the elastic sheet was stacked on the negative electrode. Thereafter, the negative electrode, the solid electrolyte layer and the positive electrode were sequentially stacked to prepare an assembly. The assembly was stacked in the following order: positive electrode/solid electrolyte/negative electrode/elastic sheet/negative electrode/solid electrolyte/positive electrode.

The assembly was inserted into a laminate film and isostatic pressurized under 500 MPa at 80° C. to fabricate an all solid-state cell.

In the pressurized state, the thickness of the positive active material layer was about 100 μm, the thickness of the negative active material layer was about 7 μm, the thickness of the solid electrolyte layer was about 60 μm, and the thickness of the elastic sheet was about 120 μm.

### Example 2

An all solid-state cell was fabricated by the same procedure as in Example 1, except that 50 wt % of a polyethylene spherical polymer having a sphericity of 0.67 (average particle diameter D50: 4 m) and 50 wt % of a polyether polyol were mixed in a toluene solvent to prepare a composition for an elastic sheet.

### Example 3

An all solid-state cell was fabricated by the same procedure as in Example 1, except that 50 wt % of a polyethylene spherical polymer having a sphericity of 0.83 (average particle diameter D50: 4 m) and 50 wt % of a polyether polyol were mixed in a toluene solvent to prepare a composition for an elastic sheet.

### Comparative Example 1

A polyether polyol binder was mixed in a toluene solvent to prepare a composition for an elastic sheet.

The resulting mixture was coated on a polyethylene terephthalate (PET) film as a release film and was irradiated with ultraviolet (UV) with a light quantity of 2000 mJ/cm² to prepare an elastic sheet adhered on the PET film.

### Comparative Example 2

An all solid-state cell was fabricated by the same procedure as in Example 1, except that 50 wt % of a polyethylene spherical polymer having a sphericity of 0.99 (average particle diameter D50: 4 m) and 50 wt % of a polyether polyol were mixed in a toluene solvent o prepare a composition for an elastic sheet.

### Comparative Example 3

An all solid-state cell was fabricated by the same procedure as in Example 1, except that 50 wt % of a polypropylene spherical polymer having a sphericity of 0.5 (average particle diameter D50: 4 m) and 50 wt % of a polyether polyol were mixed in a toluene solvent o prepare a composition for an elastic sheet.

### Comparative Example 4

An all solid-state cell was fabricated by the same procedure as in Example 1, except that 50 wt % of a polyethylene fiber polymer (length: 0.5 μm and diameter: 0.1 μm) and 50 wt % of polyether polyol binder were mixed in a toluene solvent to prepare a composition for an elastic sheet.

### Comparative Example 5

An all solid-state cell was fabricated by the same procedure as in Example 1, except that 50 wt % of a polyacryl rod polymer having a length ratio of long axis/short axis (vertical/horizon) of 3:1 and a length of 100 nm, and 50 wt % of a polyether polyol binder were mixed in a toluene solvent to prepare a composition for an elastic sheet.

### Experimental Example 1: Evaluation of Compressive Strength

The compressive strength of the elastic sheets according to Examples 1 to 3 and Comparative Examples 1 to 5 were measured.

The compression process was carried out by compressing a specimen at a compression ratio of 0.6 mm/min (10 m/sec) using a compression tester equipped with a spherical jig with a diameter of 10 mm and the compressive strength was measured when the thickness was reached to 50% of the specimen thickness. The results are shown in Table 1, as CFD 50%.

### Experimental Example 2: Evaluation of Stress Relaxation Ratio

The stress relaxation ratio for the elastic sheets of Examples 1 to 3 and Comparative Examples 1 to 5 was evaluated. The results are shown in Table 1. The stress relaxation ratio was measured by primarily compressing the elastic sheet under a pressurization condition of 2.5 kgf, immediately secondarily compressing the elastic sheet at 40 μm to measure the initial stress, and maintaining it for 60 seconds after secondary compression to measure the stress in order to calculate the stress relaxation ratio according to Equation 2.

$$Stress relaxation ratio ( \% ) = ( Stress after 60 seconds after 40 µm compression ) / ( initial stress at 40 µm ) \times 100 \qquad [ Equation 2 ]$$

### Experimental Example 3: Evaluation of Recovery Ratio

The recovery ratio for the elastic sheets of Examples 1 to 3 and Comparative Examples 1 to 5 were evaluated.

The recovery ratio was measured by primarily compressing the elastic sheet under a pressurization condition of 2.5 kgf, immediately secondarily compressing the elastic sheet at 40 μm, and maintaining it for 60 seconds to measure the initial stress at the time of the first compression and the stress at the time of returning to the secondary starting point (initial point) to calculate the recovery ratio according to Equation 3.

$$Recovery ratio ( \% ) = ( Stress at the time restoration to initial point after 40 µm ) / ( Initial stress at 40 µm compression ) \times 100 \qquad [ Equation 3 ]$$

### Experimental Example 4) Evaluation of Cycle-Life

The all solid-state cells of Examples 1 to 3 and Comparative Examples 1 to 5 were inserted into a test module and fixed with a force of 5000 gf, and then charged at a constant current of 0.1 C at 45° C. to the upper voltage limit of 4.25 V and discharged at 0.1 C to the cut-off voltage of 2.5 V to perform initial charge and discharge.

The cells initially charged and discharged were charged and discharged at 0.33 C in the voltage range of 2.5 V to 4.25 V at 45° C. for 300 cycles, and the number of cycles at which the discharge capacity relative to the initial discharge capacity was dropped to less than 90% was considered as the cycle-life. The results are shown in Table 1.

TABLE 1

| | CFD | Stress | Recovery | Cycle- |
|---|---|---|---|---|
| | 50% | relaxation | ratio | life |
| | (MPa) | ratio (%) | (%) | (Cycles) |
| Example 1 | 1.5 | 15% | 81% | >250 |
| Example 2 | 1.3 | 15% | 78% | >250 |
| Example 3 | 1.5 | 17% | 80% | >300 |
| Comparative | 0.8 | 3% | 70% | <100 |
| Example 1 | | | | |
| Comparative | 0.9 | 13% | 71% | <250 |
| Example 2 | | | | |
| Comparative | 0.8 | 12% | 72% | <250 |
| Example 3 | | | | |
| Comparative | 0.7 | 9% | 69% | <200 |
| Example 4 | | | | |
| Comparative | 0.5 | 8% | 64% | <200 |
| Example 5 | | | | |

As shown in Table 1, the elastic sheet of Examples 1 to 3 using a spherical polymer with a spherical polymer of 0.67 to 0.95 exhibited good compressive strength, a stress relaxation ratio, a recovery ratio, and cycle-life characteristics.

Whereas, Comparative Example 1 without using a spherical polymer exhibited a compressive strength of 0.8 MPa, a stress relaxation ratio of 3%, a recovery ratio of 70%, and the cycle-life of less than 100 cycles, which resulted in extremely deteriorated physical properties.

The elastic sheet of Comparative Examples 2 and 3 using a spherical polymer having a sphericity out of the range of 0.67 to 0.95 exhibited a slightly low stress relaxation ratio and cycle-life characteristics, and surprisingly low compressive strengths of 0.8 MPa and 0.7 MPa.

The elastic sheet of Comparative Example 4 and 5 using a fiber polymer or a rod polymer exhibited slightly low recovery ratios of 69% and 64% and low cycle-life characteristics of less than 200 cycles, and also very surprisingly low compressive strength of 0.7 MPa and 0.5 MPa and extremely low stress relaxation ratio of 9% and 8%.

By way of summation and review, one or more embodiments may provide an elastic sheet for an all solid-state battery which may be capable of applying uniform pressure to an electrode assembly and simultaneously improving safety in the case of an external impact.

Another embodiment may provide an all solid-state battery including the elastic sheet. An elastic sheet according to one or more embodiments may uniformly apply pressure to an electrode assembly and may provide an all solid-state battery exhibiting excellent safety in occurring the external impact, thereby providing an all solid-state battery exhibiting excellent charge and discharge characteristics and safety.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all solid-state battery, the elastic sheet comprising:
a spherical polymer having a sphericity of about 0.6 to about 0.95; and
a binder.

2. The elastic sheet for the all solid-state battery as claimed in claim 1, wherein the sphericity of the spherical polymer is about 0.67 to about 0.95.

3. The elastic sheet for the all solid-state battery as claimed in claim 1, wherein the spherical polymer comprises polyethylene, a polyacryl polymer, polyurethane, or a combination thereof.

4. The elastic sheet for the all solid-state battery as claimed in claim 1, wherein an amount of the spherical polymer is about 10 wt % to about 70 wt %, based on a total weight of the elastic sheet.

5. The elastic sheet for the all solid-state battery as claimed in claim 1, wherein an amount of the spherical polymer is about 20 wt % to about 60 wt %, based on a total weight of the elastic sheet.

6. The elastic sheet for the all solid-state battery as claimed in claim 1, wherein the spherical polymer has a particle diameter of about 0.1 μm to about 10 μm.

7. The elastic sheet for the all solid-state battery as claimed in claim 1, wherein the binder comprises polyurethane, a fluorine polymer, an acrylate resin, natural rubber, spandex, butyl rubber, an ethylene-propylene rubber, a styrene-butadiene rubber, chloroprene, elastine, rubber epichlorohydrin, nylon, terpene, isoprene rubber, polybutadiene, nitrile rubber, thermoplastic elastomer, silicon, an ethylene-propylene-diene rubber, ethylene vinyl acetate, halogenated butyl rubber, neoprene, or a copolymer thereof.

8. The elastic sheet for the all solid-state battery as claimed in claim 1, wherein the binder comprises a polyether polyol or a polyester polyol.

9. The elastic sheet for the all solid-state battery as claimed in claim 1, wherein the elastic sheet has a thickness of about 50 μm to about 800 μm.

10. A method of forming an elastic sheet for an all solid-state battery, the method comprising:
forming a composition by mixing a spherical polymer having a sphericity of about 0.6 to about 0.95 and a binder in a solvent;
coating the composition on a substrate; and
photopolymerizing or thermopolymerizing the composition.

11. The method as claimed in claim 10, wherein the solvent is toluene, benzene, or a combination thereof.

12. The method as claimed in claim 10, wherein the substrate is polyethylene terephthalate film.

13. The method as claimed in claim 10, wherein the photopolymerization is performed by irradiating the composition with an ultraviolet ray with a light quantity of about 1,000 mJ/cm² to about 3,000 mJ/cm².

14. The method as claimed in claim 10, wherein the thermopolymerization is performed by heat-treating the composition at about 70° C. to about 120° C.

15. An all solid-state battery, comprising:
a positive electrode;
a negative electrode;
a solid electrolyte layer between the positive electrode and the negative electrode; and
the elastic sheet as claimed in claim 1, positioned on outside of at least one of the positive electrode and the negative electrode.
